(19) United States
(12) Patent Application Publication
(10) Pub. No.: US 2025/0298213 A1
(43) Pub. Date: Sep. 25, 2025

(54) FIBER OPTIC SYSTEM INCORPORATING A DUCT-DEPLOYABLE MULTI-FIBER FERRULE

(71) Applicant: CommScope Technologies LLC, Hickory, NC (US)

(72) Inventor: Yu LU, Eden Prairie, MN (US)

(73) Assignee: CommScope Technologies LLC, Hickory, NC (US)

(21) Appl. No.: 18/860,524

(22) PCT Filed: Apr. 25, 2023
(86) PCT No.: PCT/US2023/019824

§ 371 Date: Oct. 25, 2024

Related U.S. Application Data
(60) Provisional application No. 63/334,552, filed on Apr. 25, 2022.

(51) Int. Cl. G02B 6/50

(52) U.S. Cl. CPC G02B 6/508

(57) ABSTRACT

The present disclosure relates to a fiber deployment system for use with field installed fiber tubes such as blown fiber tubes. The fiber deployment system includes a fiber optic connector including a housing assembly having a connector body and a fiber tube attached at a rear end of the connector body. A multi-fiber ferrule assembly mounted on a deployable fiber can be loaded into the connector body through the fiber tube. The fiber tube can be coupled a field installed fiber tube by a tube coupler.

### CROSS-REFERENCE TO RELATED APPLICATIONS

This application is being filed on Apr. 25, 2023, as a PCT International application and claims the benefit of and priority to U.S. Provisional Application No. 63/334,552, filed Apr. 25, 2022, the disclosure of which is hereby incorporated by reference in its entirety.

### TECHNICAL FIELD

The present disclosure relates to fiber optic data transmission, and more particularly to fiber optic cable connection systems.

### BACKGROUND

Fiber optic cable connection systems are used to facilitate connecting and disconnecting fiber optic cables in the field without requiring a splice. A typical fiber optic cable connection system for interconnecting two fiber optic cables includes fiber optic connectors mounted at the ends of the fiber optic cables, and a fiber optic adapter for mechanically and optically coupling the fiber optic connectors together. Fiber optic connectors generally include ferrules that support the ends of the optical fibers of the fiber optic cables. The end faces of the ferrules are typically polished and are often angled. The fiber optic adapter includes co-axially aligned ports (i.e., receptacles) for receiving the fiber optic connectors desired to be interconnected. The fiber optic adapter includes an internal sleeve that receives and aligns the ferrules of the fiber optic connectors when the connectors are inserted within the ports of the fiber optic adapter. With the ferrules and their associated fibers aligned within the sleeve of the fiber optic adapter, a fiber optic signal can pass from one fiber to the next. The adapter also typically has a mechanical fastening arrangement (e.g., a snap-fit arrangement) for mechanically retaining the fiber optic connectors within the adapter. Examples of existing fiber optic connection systems are described at U.S. Pat. Nos. 6,579,014, 6,648,520, and 6,899,467.

Hardened (e.g., ruggedized) fiber optic connection systems are often used for outside environments. Hardened fiber optic connection systems are typically environmentally sealed and include robust connection interfaces capable of accommodating relatively large pulling loads. A typical hardened connector includes a twist-to-lock fastener (e.g., a threaded fastener, a bayonet type fastener or like fastener) that engages a mating twist-to-lock interface defined by a corresponding hardened fiber optic adapter to securely retain the hardened connector within the hardened adapter. Example hardened connection systems are disclosed by U.S. Pat. Nos. 7,572,065; 7,744,288; and 7,090,406. Typical hardened fiber optic connectors are more bulky and robust than their non-hardened counterparts.

When installing a fiber optic network, it is often desired to route fiber optic cable through conduits (e.g., underground tubes, tubes in buildings, etc.). It is also desirable to use pre-terminated ferrules on the optical fibers of fiber optic cables so that termination operations can be efficiently and precisely performed in a factory environment rather than being performed in the field. Example systems having fiber optic cables with pre-terminated ferrules are disclosed by U.S. Pat. Nos. 10,895,6989; 10,591,678; and 10,976,500.

### SUMMARY

Aspects of the present disclosure relate to a fiber optic system having a duct deployable assembly including optical fibers terminated by a multi-fiber ferrule that can be deployed (e.g., blown, pushed, pulled or otherwise passed) through a duct. Once the multi-fiber ferrule has been passed through the duct, a connector assembly can be assembled about the multi-fiber ferrule to form a completed, functional fiber optic connector. In certain examples, the completed fiber optic connector can be hardened. In other examples, the completed fiber optic connector can be non-hardened. In certain examples, the multi-fiber ferrule can support at least two, four, eight, twelve, or sixteen optical fibers. In certain examples, a ferrule boot for receiving the optical fibers is installed at a back end of the multi-fiber ferrule, and the optical fibers are arranged in non-planar, grouped configuration as the optical fibers exit the ferrule boot. In certain examples, the grouped configuration extends from the boot to a cable sheath for protecting the optical fibers. In certain examples, the deployable assembly includes a spring located behind the multi-fiber ferrule through which the optical fibers may be laterally loaded into a rear spring stop. The spring can be secured to the ferrule (e.g., to the ferrule boot) during deployment through a duct. In certain examples, the connector assembly includes a connector core having an integrated rear spring stop adjacent a front end of the connector core and including a slot for allowing the ferrule and spring to be routed around the spring stop as the ferrule and spring are moved forwardly through the core during assembly. In certain examples, a front connector body can be mounted at the front end of the connector core to capture the ferrule and spring between the front connector body and the spring stop integrated with the connector core. In certain examples, a seal can be mounted about the connector core at a location rearward of the slot. In certain examples, the connector assembly can include a connector core, a front connector body, and a separate rear spring stop that is moved into a spring retaining position relative to the connector core once the ferrule and spring have been moved forwardly through the connector core. The rear spring stop can be slotted or have an open side. In certain examples, rear spring stops having multiple pieces can be used, wherein the spring stop is assembled about the fibers once the fibers have been loaded into a channel of the spring stop.

One aspect of the present disclosure relates to a fiber optic connector body adapted to receive a ferrule assembly including a multi-fiber ferrule terminating a plurality of optical fibers. In one example, the ferrule assembly is loaded into the connector body after the optical fiber and the ferrule assembly have been routed through a fiber tube. In certain examples, the ferrule assembly is loadable into the fiber optic connector body through a rear end of the fiber optic connector body. In a preferred example, a fiber tube is integrated with the rear end of the connector body and is configured such that the ferrule assembly can be inserted into the connector body through the fiber tube. In certain examples, the fiber tube is anchored and sealed relative to the rear end of the connector body prior to the connector body being used in the field (e.g., at the factory). In certain examples, the fiber tube is configured to be cut to a desired length in the field. In certain examples, a free end of the fiber tube is configured to be coupled to a free end of another fiber tube through which the optical fibers and the ferrule assembly have been routed.

Another aspect of the present disclosure relates to a system for deploying optical fibers through a first fiber tube having a first end and an opposite second end. The system includes optical fibers having ferrulized ends at which a ferrule assembly including a multi-fiber ferrule is secured. The optical fibers are coiled on a spool and the multi-fiber ferrule is configured to be routed through the first fiber tube in a direction from the first end and to the second end of the first fiber tube. The ferrule assembly, including the multi-fiber ferrule, is adapted to be incorporated as part of a multi-fiber fiber optic connector after the ferrulized end of the optical fiber has been routed through the first fiber tube. The fiber optic connector includes a connector body having a front end and a rear end. The fiber optic connector includes a second fiber tube that projects outwardly from the rear end of the connector body. The second fiber tube includes a front end anchored and sealed with respect to the connector body and a rear end positioned rearward of the rear end of the connector body. The multi-fiber ferrule is insertable through the second fiber tube and the connector body in a forward direction extending from the rear end of the connector body toward the front end of the connector body. The ferrule assembly, including the multi-fiber ferrule, is mountable adjacent the front end of the connector body upon insertion of the ferrule assembly forwardly through the second fiber tube and the connector body. The system also includes a tube coupler for coupling the second end of the first fiber tube to the rear end of the second fiber tube after the multi-fiber ferrule terminating the optical fibers has been inserted through the second fiber tube.

Another aspect of the present disclosure relates to a method for deploying a plurality of optical fibers through a first fiber tube having a first end and an opposite second end. The first fiber tube is pre-installed underground to provide a fiber routing path between a first location and a second location. The method includes routing optical fibers terminated at a multi-fiber ferrule assembly at one and through the first fiber tube in a direction from the first end to the second end of the first fiber tube. The method also includes incorporating the ferrule assembly as part of a fiber optic connector after the ferrule assembly and its corresponding optical fibers have been routed through the first fiber tube. The fiber optic connector includes a connector body having a front end and a rear end. The fiber optic connector includes a second fiber tube that projects rearwardly from the rear end of the connector body. The second fiber tube includes a front end anchored and sealed with respect to the connector body and a rear end positioned rearward of the rear end of the connector body. The ferrule assembly is installed within the connector body by inserting the ferrule assembly, including the multi-fiber ferrule, through the second fiber tube and the connector body in a forward direction extending from the rear end of the connector body toward the front end of the connector body. The ferrule assembly is secured adjacent the front end of the connector body upon insertion of the ferrule assembly forwardly through the second fiber tube and the connector body. The method further includes coupling the second end of the first fiber tube to the rear end of the second fiber tube after the ferrule assembly has been inserted through the second fiber tube. The first and second fiber tubes are coupled together by a tube coupler. In one example, the optical fibers and the multi-fiber ferrule assembly terminating the fibers are blown through the first fiber tube.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 schematically depicts an example environment in which fiber optic systems in accordance with the principles of the present disclosure can be deployed.

FIG. 2 is a cross-sectional view of an example fiber optic connector that is part of a fiber optic system in accordance with the principles of the present disclosure.

FIG. 3 depicts an example multi-fiber ferrule arrangement mounted on the ends of optical fibers of a multi-fiber cable that is coiled about a spool, the multi-fiber ferrule arrangement can be incorporated as part of the fiber optic connector of FIG. 2.

FIG. 4 is a transverse cross-sectional view taken along section line 14-14 cut through the multi-fiber cable of FIG. 3.

FIG. 5 is a schematic transverse cross-sectional view cut through a connector core of the fiber optic connector of FIG. 2.

FIG. 6 is a side, exploded view of the fiber optic connector of FIG. 2.

FIG. 7 is a longitudinal cross-sectional view taken along a portion of the length of the fiber optic connector of FIG. 6.

FIG. 8 is a cross-sectional view of an example hardened shroud that can be mounted over the connector core of the fiber optic connector of FIG. 6.

FIG. 9 depicts an example multi-fiber ferrule assembly that is loadable into the fiber optic connector of FIG. 2.

FIG. 10 depicts an alternative connector assembly in accordance with the principles of the present disclosure.

FIG. 11 is a cross-sectional view through a side cover of the connector assembly of FIG. 10.

FIG. 12 depicts an example multi-piece rear spring stop that can be used with non-hardened connector arrangements in accordance with the principles of the present disclosure.

FIG. 13 depicts the rear spring stop of FIG. 12 with a rear cap separated from a main body of the rear spring stop.

FIG. 14 is a cross-sectional view through optical fibers arranged in a non-planar, grouped configuration.

### DETAILED DESCRIPTION

Aspects of the present disclosure relate to fiber optic systems having multi-fiber ferrules that are factory terminated on the optical fibers of multi-fiber ferrules and that can also be readily deployed through fiber tubes (e.g., by blowing, pushing, or other means). An example system can include a factory terminated subassembly including a multi-fiber ferrule mounted at the terminal ends of optical fibers of a multi-fiber blowable/pushable fiber optic cable. The factory terminated subassembly can also include a multi-fiber ferrule (pinned or non-pinned), a rear ferrule boot, and a rear pin holder. The factory terminated subassembly can further include a spring mounted behind the spring holder and over the fiber optic cable. A front end of the spring can be secured to the ferrule boot. As used herein, “factory terminated” means that a ferrule is installed on the optical fibers of a cable at the factory. This can include direct terminations in which the optical fibers of a cable are extended continuously to the multi-fiber ferrule, or splice-on terminations where the ferrule supports stub optical fibers that are spliced to the optical fibers of the fiber optic cable. The ferrule assembly can be adapted to be mounted in a connector body after deployment through a fiber tube. In one example, a fiber tube is integrated (e.g., factory integrated) with the connector body adjacent a rear end of the connector body and the ferrule assembly can be loaded into the connector body through the fiber tube (e.g., loaded through the rear end of the connector body). The fiber tube can be sealed and anchored (e.g., bonded, mechanically affixed, etc.) with respect to the connector body. A free end of the fiber tube is configured to be coupled to a free end of another fiber tube through which the optical fibers have been routed. A tube coupler can be used to couple the ends of the fiber tubes together in a sealed manner. The integrated fiber tube can be configured to be cut to length in the field.

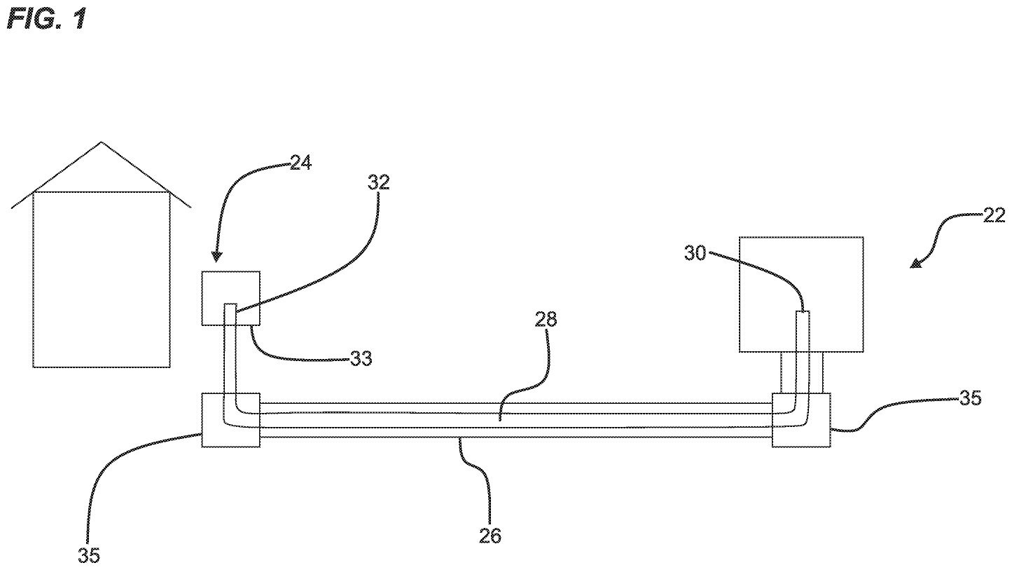

FIG. 1 depicts an example environment suitable for deploying a fiber optic system in accordance with the principles of the present disclosure. The environment includes a first location 22 such as a fiber distribution cabinet (e.g., a distribution point) and a second location 24 such as a subscriber location. An underground conduit 26 is routed at least partially between the first and second locations 22, 24. The underground conduit 26 contains at least one fiber tube 28 routed through the conduit 26 between the first and second locations 22, 24. In one example, the fiber tube 28 is a blown fiber tube configured for allowing optical fibers to be blown therethrough to deploy the optical fibers. In one example, the fiber tube has an inner diameter of at least 5 millimeters (mm), or at least 6 mm, or at least 7 mm, or at least 8 mm, or at least 9 mm. Typically, a plurality of the fiber tubes are routed through the conduit for providing fiber optic service to different subscriber locations. The fiber tube 28 includes a first end 30 that can be accessed at the first location 22 and a second end 32 that can be accessed adjacent the second location 24. It will be appreciated that the fiber tube 28 can also be routed through or to additional structures such as enclosures/terminals 33, hand holes 35, and the like.

Aspects of the present disclosure relate to a system for deploying optical fibers terminated to a multi-fiber ferrule through a fiber tube such as the fiber tube 28 depicted at FIG. 1. In one example, the system can be sold as a kit including a number of components sold and packaged together. The different components can include structures such as connector housing assemblies, fiber optic cable assemblies, and the like. In one example, the different components can include a connector housing assembly, a tube coupler, a fiber optic cable coiled about a spool, and a multi-fiber ferrule assembly mounted on optical fibers of the fiber optic cable. The ferrule assembly can be configured to be installed within the connector housing assembly after the fiber optic cable has been deployed through the fiber tube 28. The connector housing assembly can include an integrated fiber tube adapted for connection to the second end 32 of the fiber tube 28.

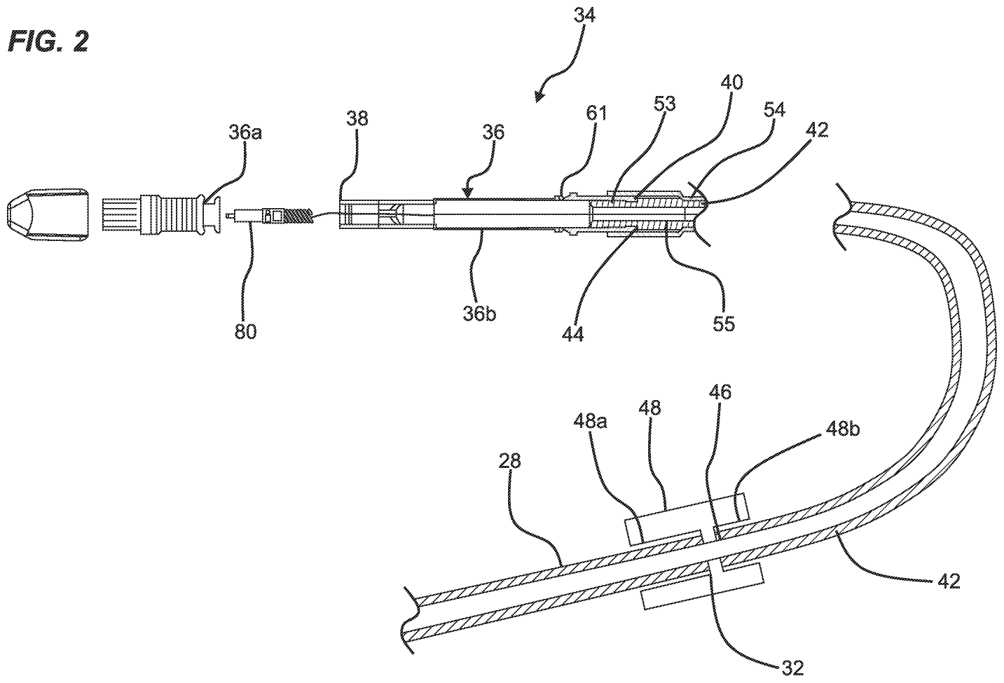

FIG. 2 depicts an example connector housing assembly 34 that can be included as part of a fiber deployment kit in accordance with the principles of the present disclosure. The connector housing assembly 34 includes a connector body 36 (e.g., a connector core) having a front end 38 and a rear end 40. The housing assembly 34 also includes a fiber tube 42 that projects rearwardly from the rear end 40 of the connector body 36. The fiber tube 42 includes a front end 44 anchored and sealed with respect to the connector body 36 and a rear end 46 positioned rearward of the rear end 40 of the connector body 36.

The housing assembly 34 further includes a tube coupler 48 adapted for connecting the second end 32 of the fiber tube 28 to the rear end 46 of the fiber tube 42. In one example, the tube coupler 48 can include a first port 48a for receiving the fiber tube 28 and a coaxial second port 48b for receiving the rear end 46 of the fiber tube 42. Teeth or other anchoring structures can be provided within the tube coupler 48 for anchoring the fiber tubes 28, 42 within the coupler 48 when the fiber tubes 28, 42 are inserted therein. Additionally, seals can be provided within the tube coupler 48 for providing sealing about the fiber tubes 28, 42.

As indicated above, the fiber tube 42 is preferably coupled to the rear end 40 of the connector body 36. Preferably, the fiber tube 42 is sealed with respect to the connector body 36. In one example, the fiber tube 42 can be connected and sealed with respect to the connector body 36 by a material such as adhesive. In other examples, the fiber tube 42 can be coupled to the connector body 36 mechanically by a fastener such as a crimp ring or other mechanical fastener. In the depicted example, the fiber tube 42 is coupled to the rear end 40 of the connector body 36 by a shape memory sleeve 54 such as a heat-shrink sleeve. In one example, the heat-shrink sleeve can include an internal layer of adhesive that bonds the heat shrink sleeve to both the exterior of the connector body 36 and the exterior of the fiber tube 42. In this way, the heat-shrink sleeve mechanically couples the fiber tube 42 to the connector by 36 and provides sealing between the fiber tube 42 and the connector body 36. As depicted, a rear insert 53 mounts within the connector body 36 and includes a barbed fitting that fits within the tube 42 to further assist in securing the tube 42 to the connector body 36. The insert 53 can be adhesively bonded in the connector body 36 or mechanically fastened to the connector body 36. A crimp ring can be used to secure the tube 42 on a barbed fitting 55.

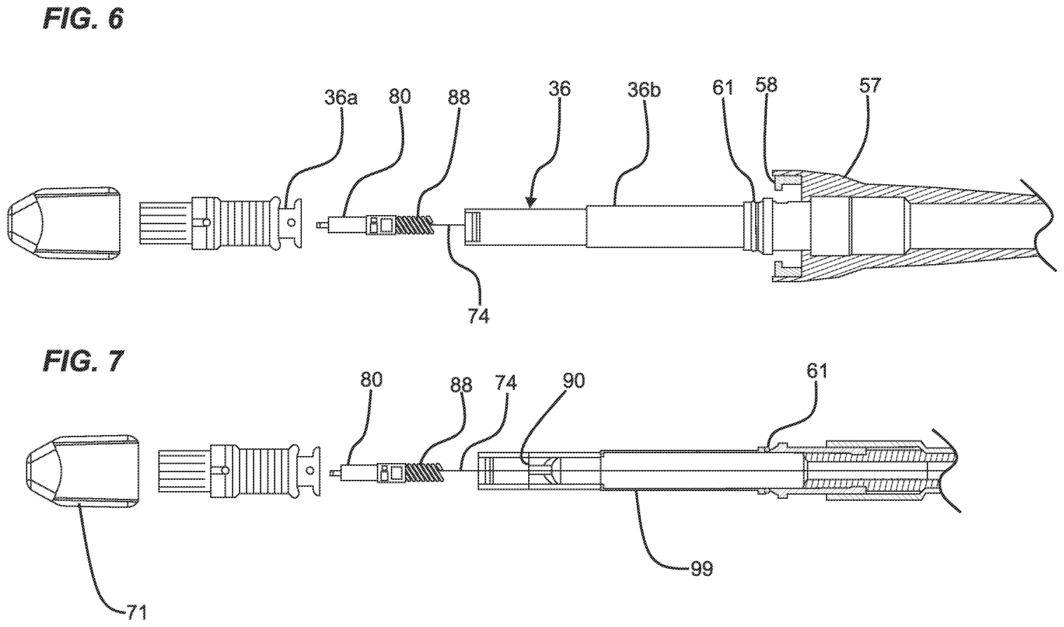

The housing assembly 34 can further include additional components such as an exterior flexible strain relief boot 57 (see FIG. 6) that mounts over the rear end of the connector body 36 and extends over a portion of the length of the fiber tube 42. In certain examples, the strain relief boot can have a plastic construction and can taper inwardly as the strain relief boot extends in a rearward direction. Additionally, the strain relief boot can be segmented to enhance flexibility.

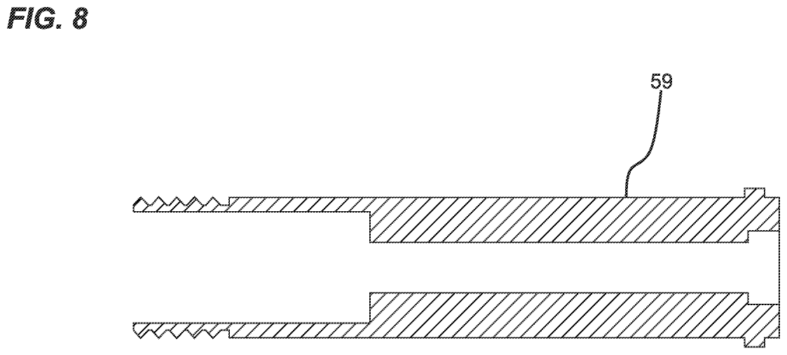

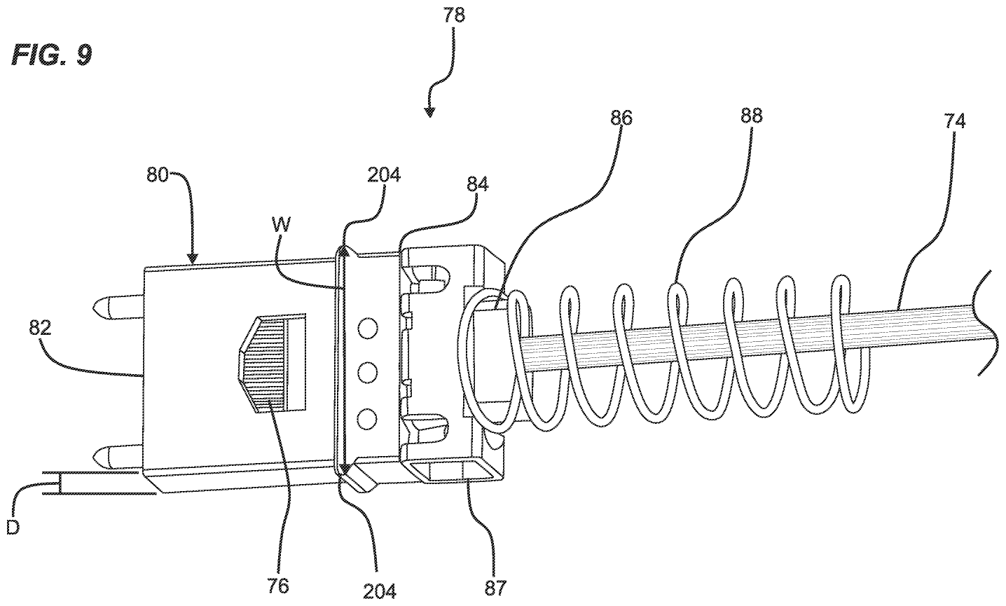

In certain examples, the connector housing assembly 34 can additionally include a fastener 58 (see FIG. 6) for use in coupling the housing assembly 34 to a corresponding fiber optic adapter once the housing assembly 34 has been integrated with a fiber ferrule assembly to form a multi-fiber optical connector. The fastener 58 can also be used to secure one or more shroud assemblies (e.g., see shroud assembly 59 at FIG. 8) over the exterior of the connector body 36. The shroud assemblies can be adapted to convert the connector body 36 to be compatible with different styles of fiber optic adapters or connectors. In certain examples, the shroud assemblies can include structures for providing keying with respect to their corresponding mating fiber optic adapters or connectors. Additionally, the shroud assemblies can include one or more internal or external seals for sealing within respect to a mating components (e.g., a mating fiber optic adapter or connector). The fastener 58 can be a turn-to-lock fastener such as a threaded fastener, a quarter-turn interlock fastener as disclosed in PCT International Publication Number WO 2021/041305, or bayonet style fastener. Further details about the shroud assembles and fasteners are disclosed in PCT International Publication Number WO 2021/041305 which is hereby incorporated by reference in its entirety. In other examples, shrouds can be secured on the connector housing assembly 34 by a pushable locking configuration (e.g., via resilient latches that provide a snap-fit interlock when the shroud is inserted (e.g., pushed) linearly over the connector assembly). For example, locking features (e.g., stops, projections, openings, etc.) on the connector body 36 can interlock with resilient latches (e.g., clips, cantilevers, snaps, tabs) provided as part of the shrouds. In other examples, the shrouds can be retained on the connector body 36 by a front connector housing that mounts at the front end of the connector body 36 and is capable of capturing the shroud in a mounted position on the connector body 36 to prevent the shroud from being forwardly removed from the connector body 36. A rear stop on the connector body can prevent the shroud from being rearwardly removed from the connector. To install the shroud, the shroud is inserted over the front end of the connector body 36 until the shroud engages the rear stop. Once the shroud is inserted over the connector body 36, the front connector housing is secured to the front end of the connector body (e.g., by a snap-fit connection), thereby capturing the shroud between the front connector housing and the rear stop such that the shroud is retained on the connector body between the rear stop and the front connector housing.

A seal 61 (e.g., an elastomeric seal that in one example is an o-ring) can be mounted on the connector body 36 (e.g., around the exterior of the connector body 36) for sealing within respect to the interior of a shroud mounted over the connector body or for sealing with respect to a mating connector or fiber optic adapter.

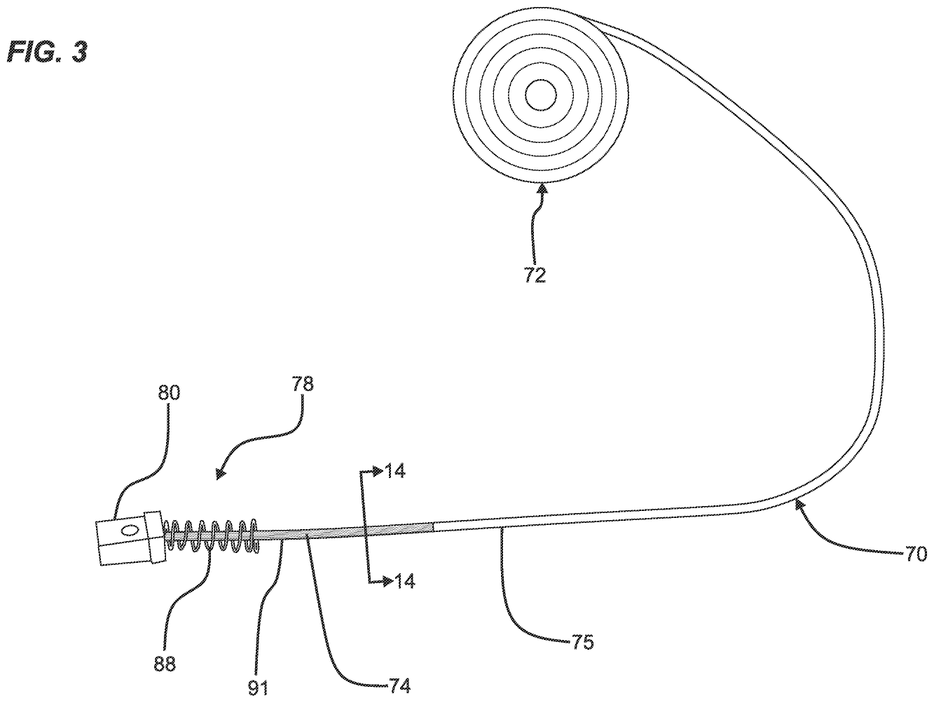

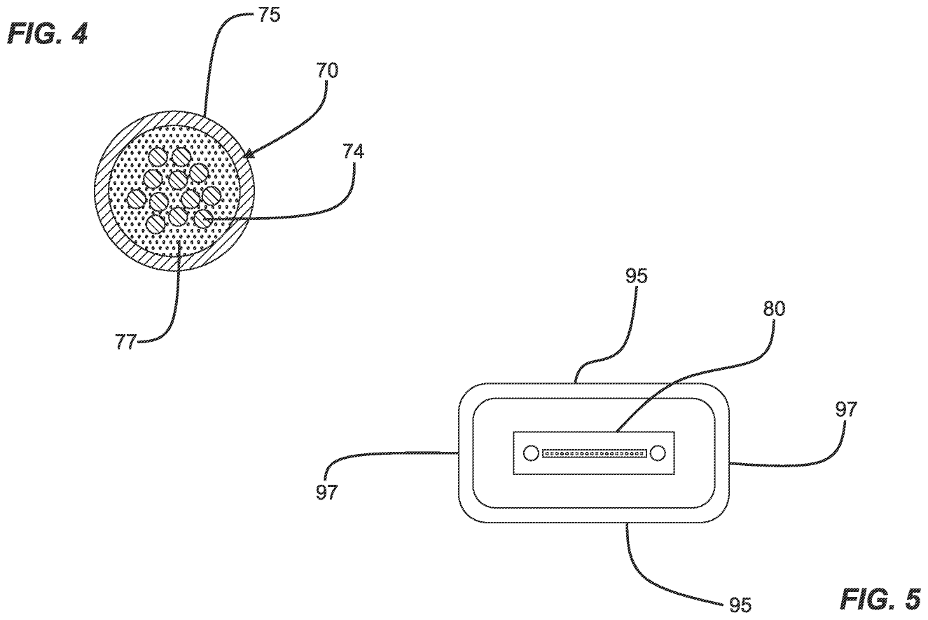

FIG. 3 depicts another component that can be incorporated into a fiber deployment kit in accordance with the principles of the present disclosure. The component includes a multi-fiber fiber optic cable 70 coiled about a spool 72. The fiber optic cable 70 includes a plurality of optical fibers 74. In certain examples, the fiber optic cable 70 can include structure for protecting and/or reinforcing the optical fiber 74. As shown at FIG. 4, the cable 70 can include an outer jacket 75 and the optical fibers can be arranged in a centrally located, grouped, non-planar configuration within the jacket 75. Encapsulation material 77 can fill voids within the jacket 75.

The optical fibers 74 include ferrulized ends 76 at which a multi-fiber ferrule assembly 78 is secured. In the field, the ferrulized ends 76 are configured to be routed through the fiber tube 28 in a direction from the first end 30 to the second end 32. For example, the cable 70 can be blown, pushed, or pulled through the fiber tube 28 with the ferrule assembly 78 leading the cable 70. In certain examples, a protective housing or cap can be provided over the ferrule assembly 78 during deployment through the fiber tube 28. The cap 71 can cover the end face of a ferrule of the ferrule assembly to keep the end face clean and to protect protruding pins (in examples where pins are provided). The cap can have rounded corners for a streamlined configuration. The cap can secure to the ferrule assembly by a friction fit, or by a latching arrangement. The front of the ferrule assembly, including the cap, can be designed for easy guiding inside the tube 28, and also to provide finger access for facilitating removal of the protective cap after deployment. The protective cap can be configured to cover only a front of the ferrule assembly, or the entire ferrule, or the entire ferrule and the pin holder, or the entire ferrule, the pin holder, and the spring. In certain examples, the protective cap can be made of a flexible material (e.g., an elastomeric material) configured to flex as the ferrule assembly is pushed/blown through the tube 28. In certain examples, the spool 72 can rotate to allow the cable 70 to be paid off from the spool 72 as the cable 70 is routed through the fiber tube 28.

In one example, the ferrule assembly 78 can include a multi-fiber ferrule 80 in which the optical fibers 74 are mounted. The multi-fiber ferrule 80 can include a front end 82 and a rear or base end 84. The optical fibers 74 can have polished or otherwise processed end faces located at the front end 82 of the multi-fiber ferrule 80. In certain examples, the optical fibers 74 are secured within fiber passages of the multi-fiber ferrule 80 by adhesive such as epoxy. The ferrule assembly 78 can also include a ferrule boot 86 mounted to the rear end 84 of the multi-fiber ferrule 80 as well as a pin holder 87 secured at the rear of the multi-fiber ferrule 80. In the case where alignment pins are provided at the front face of the multi-fiber ferrule 80, base ends of the pins are secured in the pin holder 87. In the case where alignment pins are not used, the pin holder can still be present at the rear of the multi-fiber ferrule 80 but does not provide a pin holding function. The ferrule assembly 78 can also include a spring 88 positioned behind the pin holder 87. The front end of the spring 88 can be secured to the ferrule boot 86. For example, the front end of the spring 88 can be press fit on the boot 86, mechanically interlocked with the boot, or adhesively bonded to the boot 86. The rear end of the spring 88 can have adjacent coil sections bonded to one another to form more of a closed ring at the end of the spring as compared to a helix.

In one example, the multi-fiber ferrule can have a maximum width W of 7.0 mm and a maximum depth D of 3.0 mm. Of course, other sizes can be used. In one example, the ferrule can support twelve fibers. But, in other examples, other fiber counts can also be supported such as four, six, eight, or sixteen fibers.

The boot 86 can have an elastomeric construction and can be bonded within the ferrule. The optical fibers 74 exit the rear of the multi-fiber ferrule 80 through the boot 86. A fiber transition region 91 exists between the boot 86 and a jacketed portion of the cable 70. The optical fibers 74 have a non-planar, grouped configuration as the fibers 74 exit the rear of the boot 86. The non-planar, grouped configuration can extend from the rear of the boot 86 to the jacketed portion of the cable 70. The non-planar, grouped configuration can be referred to as a bundled configuration, but a binder is not required to retain the fibers 74 in the bundled configuration. For example, the boot 86 and the cable can cooperate to retain the fibers 74 in the bundled configuration without requiring a binder that extends across the fiber transition region 91 (the fibers are arranged in a loose bundle). In other examples, a binder (e.g., a thread) can be used to provide a tighter bundle. In still other examples, the optical fibers of the bundled configuration are arranged in a rolled configuration which is possible in cases where the fibers are part of a rollable ribbon. In other examples, the bundled fibers of the fiber transition region 91 are contained in a soft tube that extends between the ferrule boot and the cable jacket. In still other examples, the bundled fibers are bound together by a soft, flexible elastomer that extends with the fibers along the length of the fiber transition region 91. The elastomer can be continuous or intermittent. FIG. 14 is a cross-sectional view depicting an example bundled configuration.

The ferrule assembly 78 is adapted to be mounted within the connector housing assembly 34 after the ferrulized end 76 of the fiber optic cable 70 has been routed through the fiber tube 28 to the second location 24. To install the ferrule assembly 78 within the housing assembly 34, the ferrulized end 76 of the fiber optic cable 70, which includes the ferrule assembly 78 (including the multi-fiber ferrule), is inserted through the fiber tube 42 and the connector body 36 in a forward direction extending from the rear end 40 of the connector body 36 toward the front end 38 of the connector body 36. The ferrule assembly 78 is mountable adjacent the front end 38 of the connector body 36 upon insertion of the ferrule assembly 78 forwardly through the fiber tube 42 and the connector body 36. In one example, the connector body 36 can include a front portion 36a and a rear portion 36b that can be connected and disconnected with respect to one another. In one example, the front portion and the rear portion 36a, 36b can be coupled together by a snap-fit connection. The front portion 36a can define a plug having a form factor suitable to interface with a corresponding fiber optic adapter or another connector. For example, the front portion 36a can be configured with a form factor corresponding to an MPO or MT connector. The front portion 36a can be referred to as a front connector housing and can include a plug for supporting the multi-fiber ferrule. In some examples, a release sleeve can be mounted on the front portion 36a. In other examples, the release sleeve can be eliminated.

Referring to FIGS. 6 and 7, the front end of the rear portion 36b includes a spring stop 90. The rear portion 36b can have an elongate transverse cross-sectional shape (see FIG. 5) and can define major sides 95 and minor sides 97. A longitudinal slot 99 can be defined adjacent the front end of the rear portion 36b for allowing the ferrule assembly 78 to be routed out of the interior of the rear portion 36b and around the spring stop 90 such that the rear end of the spring 88 can seat against the front of the spring stop 90. The front portion 36ba can include an internal stop that opposes the front side of a flange of the multi-fiber ferrule 80 such that the ferrule assembly 78 is captured between the stop of the front portion 36a and the spring stop 90 of the rear portion 36b when the ferrule front portion 36a is secured to the rear portion 36b. The slot 99 can be defined in either one of the major sides 95 or one of the minor sides 97. A cover can mount to the rear portion 36b to cover the slot 99. In the depicted example, a rear end of the slot 99 is positioned forward of the seal 61. Hence, when a shroud is mounted over the connector body 36, the seal 61 seals against the shroud at a location rearward of the slot 99. In this way, the shroud can be used to provide an effective sealing barrier about the connector body 36 when coupled in sealed relation with respect to a mating connector or adapter.

As shown at FIG. 2, the tube coupler 48 has been used to couple the rear end 46 of the fiber tube 42 to the second end 32 of the fiber tube 28. It will be appreciated that the fiber tube 42 can be factory installed on the connector body 36 and can initially have a length L at the time of initial shipment to the field location. However, the length L of the fiber tube 42 can be changed in the field by cutting off a rear end portion of the fiber tube 42. For example, by cutting, the length of the fiber tube 42 can be adjusted in the field to match a length of the optical fibers 74 that projects beyond the second end 32 of the fiber tube 28 upon deployment of the fiber optic cable 70 within the fiber tube 28. In one example, at the time of shipment, the fiber tube 42 can have a factory manufactured length that is at least 0.25 meters (m) long, or is at least 0.5 m long, or is at least 0.75 m long, or is at least 1 m long. In another example, the factory manufactured length of the fiber tube 42 prior to being cut can be in the range of 0.25 m to 3 m, or in the range of 0.25 m to 2 m, or in the range of 0.25 m to 1 m.

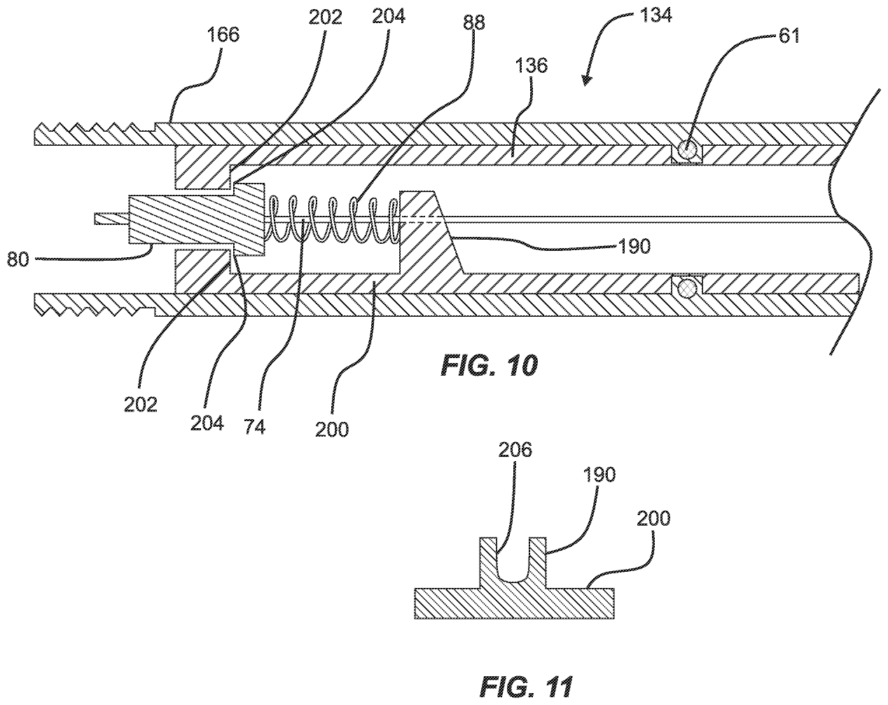

FIGS. 10 and 11 show an alternative housing assembly 134 that includes a spring stop 190 integrated with a side cover 200 that mounts at a side of the connector body 136. The spring stop defines a slot 206 through which the fibers 74 routed through the spring 88 can extend. The ferrule assembly 78 is loadable into the connector body 136 through a rear of the connector body 136. The connector body 136 includes front stops 202 that oppose flanges 204 of the ferrule 80 to stop forward movement of the ferrule 80. Once the ferrule assembly 78 has been forwardly loaded into the connector body 136, the cover 200 can be mounted to the connector body 136 such that the spring 88 is captured between the spring stop 190 and the pin holder of the ferrule. A hardened shroud 166 is shown mounted over the connector body 136. The seal 61 seals within the inside of the shroud 166.

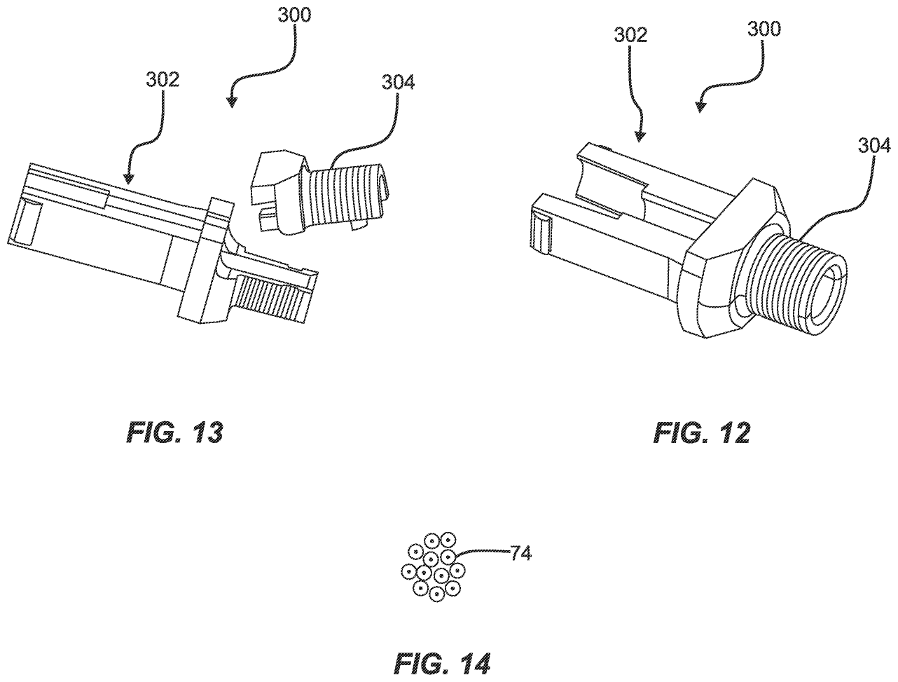

FIGS. 12 and 13 show a multi-piece rear spring stop 300 having a main body 302 and a cap 304. The multi-piece spring stop 300 can be used with non-hardened versions of systems in accordance with the principles of the present disclosure. For example, once the ferrule assembly 78 has been routed through a duct, the spring stop 300 can be installed behind the spring 88. By removing the cap 304, the fibers can be laterally inserted through a longitudinal channel defined by the main body 302. Once the fibers are in the channel, the cap 304 can be attached to the main body 302 to capture the fibers within the channel. The main body 302 can then be snapped within the front portion 36a depicted at FIG. 6 to complete the assembly of a non-hardened multi-fiber optical connector such as an MPIO connector.

From the forgoing detailed description, it will be evident that modifications and variations can be made in the devices of the disclosure without departing from the spirit or scope of the invention.

What is claimed is:

1. A system for deploying optical fibers through a first fiber tube having a first end and an opposite second end, the system comprising:
optical fibers having ferrulized ends at which a ferrule assembly including a multi-fiber ferrule is secured, the ferrulized ends being configured to be routed through the first fiber tube in a direction from the first end to the second end of the first fiber tube, the ferrule assembly being adapted to be incorporated as part of a fiber optic connector after having been routed through the first fiber tube;
the fiber optic connector including a connector body having a front end and a rear end, the fiber optic connector including a second fiber tube that projects rearwardly from the rear end of the connector body, the second fiber tube including a front end anchored and sealed with respect to the connector body and a rear end positioned rearward of the rear end of the connector body, the ferrulized ends of the optical fibers, including the multi-fiber ferrule, being insertable through the second fiber tube and the connector body in a forward direction extending from the rear end of the connector body toward the front end of the connector body, the ferrule assembly being mountable adjacent the front end of the connector body upon insertion of the ferrule assembly forwardly through the second fiber tube and the connector body; and
a tube coupler for coupling the second end of the first fiber tube to the rear end of the second fiber tube after the ferrulized ends of the optical fibers have been inserted through the second fiber tube.

2. The system of claim 1, wherein the second fiber tube is secured to the connector body by adhesive.

3. The system of claim 1, wherein the second fiber tube is secured to the connector body by a heat shrink tube.

4. The system of claim 1, wherein the second fiber tube is factory pre-installed to the connector body prior to the fiber optic connector being used in the field.

5. The system of claim 1, wherein the second fiber tube initially includes a first length and is configured to be cut to a shorter second length in the field prior to coupling the first and second fiber tubes together with the tube coupler.

6. The system of claim 5, wherein the second length is selected to correspond to a distance the ferrulized ends of the optical fibers project beyond the second end of the first fiber tube.

7. The system of claim 5, wherein the first length is at least 0.25 meters long, or is at least 0.5 meters long, or is at least 0.75 meters long, or is at least 1 meter long.

8. The system of claim 5, wherein the first length is in the range of 0.25 meters to 3 meters, or in the range of 0.25 meters to 2 meters, or in the range of 0.25 meters to 1 meter.

9. The system of claim 1, wherein the first and second fiber tubes are blown fiber tubes.

10. The system of claim 9, wherein the first and second tubes each have an inner diameter of about at least 5, 6, 7, 8, or 9 millimeters.

11. The system of claim 1, wherein the tube coupler co-axially connects the first and second fiber tubes together in a sealed manner.

12. The system of claim 1, wherein the ferrule assembly includes a ferrule boot mounted at a rear end of the multi-fiber ferrule, a pin holder mounted at the rear end of the multi-fiber ferrule, and a ferrule spring positioned behind the pin holder.

13. The system of claim 1, wherein the ferrule assembly includes a ferrule boot mounted at a rear end of the multi-fiber ferrule, and wherein the optical fibers exit the ferrule boot in a non-planar, grouped configuration.

14. The system of claim 13, wherein the optical fibers are position within a cable jacket of a blowable cable, and wherein the non-planar, grouped configuration extends across a fiber transition from the ferrule boot to an end of the cable jacket.

15. The system of claim 1, wherein the ferrule includes a front end and a rear end, and wherein in the front end of the ferrule includes a front end face at which the optical fibers terminate.

16. The system of claim 15, wherein the ferrule is an MPO ferrule.

17. The system of claim 1, further comprising an outer shroud that mounts over the connector body.

18. A method for deploying optical fibers through a first fiber tube having a first end and an opposite second end, the first fiber tube having been pre-installed underground to provide a fiber routing path between a first location and a second location, the method comprising:
routing optical fibers having ferrulized ends through the first fiber tube in a direction from the first end to the second end of the first fiber tube, the ferrulized ends including a ferrule assembly including a multi-fiber ferrule;
incorporating the ferrule assembly as part of a fiber optic connector after the ferrulized ends of the optical fibers have been routed through the first fiber tube, the fiber optic connector including a connector body having a front end and a rear end, the fiber optic connector including a second fiber tube that projects rearwardly from the rear end of the connector body, the second fiber tube including a front end anchored and sealed with respect to the connector body and a rear end positioned rearward of the rear end of the connector body, the ferrule assembly being installed within the connector body by inserting the ferrule assembly through the second fiber tube and the connector body in a forward direction extending from the rear end of the connector body toward the front end of the connector body and then securing the ferrule assembly being mounted adjacent the front end of the connector body upon insertion of the ferrule assembly forwardly through the second fiber tube and the connector body; and
coupling the second end of the first fiber tube to the rear end of the second fiber tube after the ferrulized ends of the optical fibers have been inserted through the second fiber tube, the first and second fiber tubes being coupled together by a tube coupler.

19. The method of claim 18, wherein the optical fibers are blown through the first fiber tube along with the multi-fiber ferrule.

20. A system for deploying optical fibers through a first fiber tube having a first end and an opposite second end, the system comprising:
optical fibers having ferrulized ends at which a ferrule assembly including a multi-fiber ferrule is secured, the ferrulized ends being configured to be routed through the first fiber tube in a direction from the first end to the second end of the fiber tube, the ferrule assembly being adapted to be incorporated as part of a fiber optic connector after having been routed through the first fiber tube; and
the fiber optic connector including a connector body having a front end and a rear end, the ferrulized ends of the optical fibers, including the multi-fiber ferrule, being insertable through the connector body in a forward direction extending from the rear end of the connector body toward the front end of the connector body, the ferrule assembly being mountable adjacent the front end of the connector body upon insertion of the ferrule assembly forwardly the connector body.

21. The system of claim 20, wherein the multi-fiber ferrule supports at least eight of the optical fibers.

22. The system of claim 20, wherein the multi-fiber ferrule supports at least twelve of the optical fibers.

23. The system of claim 20, wherein the multi-fiber ferrule is an MPO ferrule.

24. The system of claim 20, wherein the connector body includes a spring stop positioned adjacent the front end of the connector body and defines a longitudinal slot for allowing the ferrule assembly to be routed out of an interior of the connector body and around the spring stop.

25. The system of claim 24, further comprising an outer seal mounted around the connector body at a location rearward of the longitudinal slot.

26. The system of claim 25, further comprising a shroud that mounts over the connector body by moving the shroud over the connector body in a direction toward the rear end of the connector body, wherein the outer seal forms a seal with an interior of the shroud.

27. The system of claim 26, wherein the seal is a radial seal.

28. The system of claim 20, further comprising a ferrule boot mounted at a rear of the multi-fiber ferrule, wherein the optical fibers exit the ferrule boot in a non-planar, grouped configuration.

29. The system of claim 20, further comprising a cover with a spring stop that mounts to the connector body, wherein the spring stop opposes a rear end of a spring of the ferrule assembly when the fiber optic connector is assembled.

30. A system for deploying optical fibers through a first fiber tube having a first end and an opposite second end, the system comprising:
optical fibers having ferrulized ends at which a ferrule assembly including a multi-fiber ferrule is secured, the ferrulized ends being configured to be routed through the first fiber tube in a direction from the first end to the second end of the first fiber tube, the ferrule assembly being adapted to be incorporated as part of a fiber optic connector after having been routed through the first fiber tube; and
the fiber optic connector including a front housing portion for receiving the multi-fiber ferrule, the fiber optic connector including a rear spring stop that mounts at a rear end of the front housing portion for capturing the ferrule assembly within the front housing portion, the rear spring stop having a multi-piece construction that allows the optical fibers to be laterally loaded into the rear spring stop.
